(19) United States
(12) Patent Application Publication
(10) Pub. No.: US 2010/0159306 A1
(43) Pub. Date: Jun. 24, 2010

(54) DEVICE HAVING AT LEAST ONE ELECTROCHEMICAL CELL, AND METHOD FOR OPERATING A DEVICE HAVING AT LEAST ONE ELECTROCHEMICAL CELL

(76) Inventor: Stephan Leuthner, Leonberg (DE)

Correspondence Address: MICHAEL J. STRIKER, 103 EAST NECK ROAD, HUNTINGTON, NY, 11743, US

(21) Appl. No.: 12/296,195

(22) PCT Filed: Dec. 12, 2007
(86) PCT No.: PCT/EP07/63794

§ 371 Date: Oct. 6, 2008

(30) Foreign Application Priority Data
Jan. 17, 2007 (DE) 10 2007 002 444.6

(51) Int. Cl. H01M 2/12

(52) U.S. Cl. 429/53

(57) ABSTRACT

The invention is based on a device having at least one electrochemical cell (20, 30).

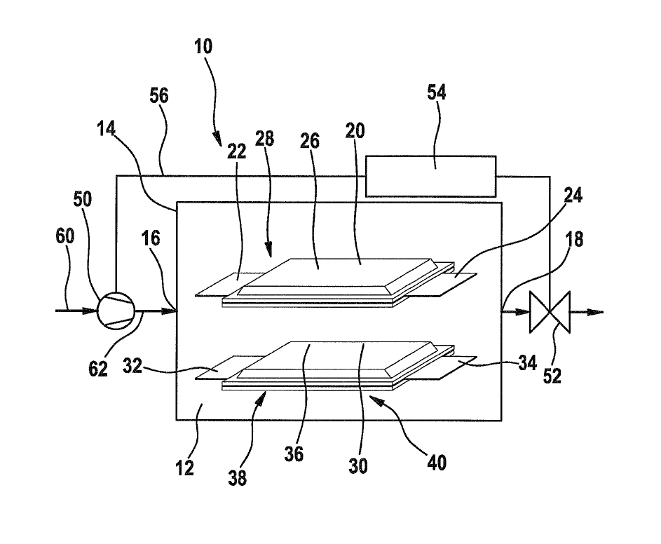

It is proposed that a volume (12) for receiving the at least one cell (20, 30), which volume is capable of being subjected to pressure by a pressure medium, is provided for subjecting the at least one cell (20, 30) to external pressure.

### PRIOR ART

The invention is based on a device having at least one electrochemical cell, and a method for operating a device having at least one electrochemical cell, as generically defined by the preambles to the independent claims.

It is known that the service life of lithium-ion batteries suffers if they are exposed to relatively high temperatures during operation.

From European Patent Disclosure EP 1 577 973 A1, it is known to embody lithium-ion batteries as rectangular flat cells. They are typically combined into a plurality of modules and connected electrically parallel and/or in series. Upon charging and discharging, heat occurs in the cells, causing the battery temperature to rise. Above the range from 45° C. to 70° C., chemical reactions take place in the lithium-ion batteries that lead to increased aging. The cells are therefore cooled in the modules, for instance by gas, liquid or vapor. Usually, air is used for the purpose, which is moved past the faces of the individual cells. The known flat cells are constructed of plastic-coated aluminum foils that are joined together, with the current conductors extended to the outside laterally and sealed off. In the interior of the cells, gas can form over the course of time; this causes the aluminum package to bulge or causes leaks at the seams, especially in the region of the current diverters. This phenomenon is amplified still further because the cells also contain so-called electrolytes, which have a vapor pressure that increases with increasing temperature. This makes cooling increasingly more difficult.

In addition, the operating parameters of this type of battery fluctuate sharply as a function of temperature. Adequate cooling is a peripheral condition that must be met, if lithium-ion batteries are to be appropriately used in sophisticated systems such as hybrid motor vehicles, or in electric power tools.

### DISCLOSURE OF THE INVENTION

The invention is based on a device having at least one electrochemical cell.

A volume for receiving the at least one cell is proposed that can be subjected to pressure by a pressure medium, for subjecting the at least one cell to external pressure. As a result, upon a pressure buildup in the cell, the buildup can be counteracted by exerting a pressure on the cell from outside. A pressure can be suitably adjusted. Preferably, the pressure is at least equal to the internal pressure of the cells, and especially preferably, it is substantially greater. Deformation of the cell housing and resulting leaks can thus be avoided. The service life of the cell can be improved. Especially in modules having a plurality of cells, such as battery packs for hybrid motor vehicles, electrically operated vehicles such as wheelchairs, bicycles with an electric auxiliary drive, forklifts, or driverless transport systems, and such as battery packs for power tools, an advantageous lengthening of the service life can be achieved as a result of subjecting the cells to external pressure. The invention is suitable not only for batteries, in which case lithium-ion secondary batteries are preferred, but fundamentally for so-called electrochemical battery cells as well.

In a favorable refinement, the at least one cell can be disposed in a housing that has a media inlet for delivering the pressure medium and a media outlet for removing the pressure medium. The pressure medium is preferably air, which is adjusted with a regulatable throttling valve, depending on the internal pressure of the at least one cell. A liquid as the pressure medium is also conceivable, such as water or a liquid coolant and the like. Vapor can also be used as a pressure medium, such as a refrigerant from an air conditioning system, or supercritical media such as carbon dioxide. In a preferred application of the device of the invention in a hybrid vehicle, it is advantageous that typically, various suitable media such as water, air, and air conditioning refrigerant are available, and furthermore suitable equipment is on hand for tempering the pressure medium.

For delivering the pressure medium, a compressor device can expediently be provided, preferably a compressor. The pressure can advantageously be adapted to the internal pressure of the at least one cell for the sake of saving energy. An unnecessary and energy-intensive pressure buildup can be avoided.

For removing the pressure medium, a throttle device can expediently be provided, so that the pressure medium can expediently be throttled again downstream of the volume that can be subjected to pressure. It can be advantageous if the throttle device is embodied as an expansion device, such as an expander. The throttle device can for instance be a throttle valve as well. The throttle device is preferably capable of being blocked, so that if a system supplied by the at least one cell is at a standstill, the at least one cell can be kept constantly under pressure. As a result, cell deformation and attendant leakage are additionally prevented.

It is especially energy-saving if the throttle device embodied as an expansion device is coupled in terms of its drive to the compressor device.

A pressure of the pressure medium can advantageously be adjustable in the volume that can be subjected to pressure, as a function of an internal pressure of the at least one cell; a regulator is preferably provided for the purpose.

The invention is also based on a method for operating a device having at least one electrochemical cell.

It is proposed that the at least one electrochemical cell be subjected externally to a pressure of a pressure medium. The at least one cell can be subjected to a homogeneous pressure by the pressure medium on all sides. Preferably, the pressure is adjusted to be at least as great or even substantially greater than the internal pressure of the at least one cell.

The at least one cell can be cooled with the pressure medium.

Preferably, the pressure can be adjusted as a function of an internal pressure of the at least one cell. If a module having a plurality of such cells is used, then expediently the pressure is adjusted in accordance with the cell having the highest internal pressure. A determination of the internal pressure can be derived for instance from a cell temperature of one cell. In a module, the cell having the highest temperature can then be used in each case.

Advantageously, the subjection to pressure can also be effected such that even if the cell or cells need not be cooled, the throttle device is completely closed, so that a high pressure is preserved in the volume that can be subjected to pressure.

### BRIEF DESCRIPTION OF THE DRAWINGS

Drawing

Further advantages will become apparent from the ensuing drawing description. In the drawing, exemplary embodiments of the invention are shown. One skilled in the art will expediently also consider the characteristics disclosed in the drawing, specification and claims in combination and put them together to make appropriate further combinations.

The sole drawing FIGURE schematically shows a preferred device having a plurality of electrochemical cells in a volume that can be subjected to pressure.

### EMBODIMENT OF THE INVENTION

The drawing, for illustrating the invention, shows a preferred device 10 with an electrochemical module 40 comprising a plurality of electrochemical cells 20, 30 that are connected electrically parallel and/or in series. The cells 20, 30 are disposed in a volume 12, which can be subjected to pressure by a pressure medium, in a preferred housing 14. The cells 20, 30 are preferably embodied as lithium-ion secondary batteries of flat cell construction and have a flat rectangular housing 26 and 36, respectively, each with current diverters 22, 24 and 32, 34, respectively, on opposite ends of the housing 26, 36. Together, the cells 20, 30 form a battery pack located in a pressure housing. The cells 20, 30 can be embodied on the order of so-called “coffee bag” cells, in which a lined metal foil surrounds an electrode pack and conforms to it. Accordingly, the cells 20, 30 are embodied as relatively soft.

The housing 14 has a media inlet 16 for delivering the pressure medium and a media outlet 18 for removing the pressure medium. Upstream of the media inlet for delivering the pressure medium, there is a compressor device 50, which compresses the pressure medium to a desired pressure 62. Downstream of the media outlet 18 is a throttle device 52 for removing the pressure medium. The pressure medium can expand again there. The throttle device 52 is connected to the compressor device 50, embodied for instance as a compressor, via a regulator 54, which is located in a regulating line 56. The pressure medium is simultaneously the cooling medium for the cells 20, 30.

A pressure 62 of the pressure medium in the volume 12 that can be subjected to pressure is adjustable as a function of an internal pressure of the at least one cell 20, 30, in that the regulator adjusts the compression power of the compressor device 52 embodied as a compressor.

The pressure 62 of the pressure medium is adjusted as a function of an internal pressure 28, 38 of the at least one cell 20, 30. Expediently, the adjustment will be oriented to the cell 20, 30 having the highest internal pressure 28, 38.

1. A device having at least one electrochemical cell (20, 30), characterized by a volume (12) for receiving the at least one cell (20, 30), the volume being capable of being subjected to pressure by a pressure medium, for subjecting the at least one cell (20, 3Q) to external pressure.

2. The device as defined by claim 1, characterized in that the at least one cell (20, 30) is located in a housing (14), which has a media inlet (16) for delivering the pressure medium and a media outlet (18) for removing the pressure medium.

3. The device as defined by claim 1, characterized in that for delivering the pressure medium, a compressor device (50) is provided.

4. The device as defined by claim 1, characterized in that for removing the pressure medium, a throttle device (52) is provided.

5. The device as defined by claim 4, characterized in that the throttle device (52) is embodied as an expansion device.

6. The device as defined by claim 5, characterized in that the throttle device (52) embodied as an expansion device is coupled in terms of its drive to the compressor device (50).

7. The device as defined by claim 1, characterized in that a pressure of the pressure medium in the volume (12) that is capable of being subjected to pressure is adjustable as a function of an internal pressure of the at least one cell (20, 30).

8. A method for operating a device having at least one electrochemical cell (20, 30), in particular as defined by one of the foregoing claims, characterized in that the at least one cell (20, 30) is subjected externally to a pressure (62) of a pressure medium.

9. The method as defined by claim 8, characterized in that the at least one cell (20, 30) is cooled by the pressure medium.

10. The method as defined by claim 8, characterized in that the pressure (62) is adjusted as a function of an internal pressure (28, 38) of the at least one cell (20, 30).
